(19) United States
(12) Patent Application Publication
(10) Pub. No.: US 2003/0161426 A1
(43) Pub. Date: Aug. 28, 2003

(54) Bit error measuring apparatus and trigger signal generating circuit for the bit error measuring apparatus

(76) Inventors: Kenji Dairi, Yokohama-shi (JP); Seiichi Tsutsumi, Tokyo (JP)

Correspondence Address: FISH & RICHARDSON P.C., 45 ROCKEFELLER PLAZA, SUITE 2800, NEW YORK, NY, 10111, US

(21) Appl. No.: 10/371,633

(22) Filed: Feb. 20, 2003

(30) Foreign Application Priority Data
Feb. 25, 2002 (JP) P. 2002-047667

(51) Int. Cl. H04L 7/00

(52) U.S. Cl. 375/354

(57) ABSTRACT

The trigger signal generating circuit includes a comparing section for comparing a predetermined waiting pattern with a parallel pattern which is outputted from an M sequential random pattern generator, before carrying out multiplexing, a first retiming section for carrying out a retiming with respect to a pattern coincident signal which is outputted from the comparing section, in accordance with a low speed clock signal, and a second retiming section for carrying out a retiming with respect to a retiming signal which is outputted from the first retiming section, in accordance with a high speed clock signal, wherein the second retiming section outputs an output signal used as the trigger signal.

### BACKGROUND OF THE INVENTION

1. Field of the Invention

The present invention relates to a trigger signal generating circuit capable of generating a trigger signal with an optional bit phase of an M sequential random pattern that is for use in confirming an error phenomenon based on the M sequential random pattern, by an oscilloscope, in a bit error measuring apparatus for measuring a bit error after allowing the M sequential random pattern which is a measuring pattern generated from a PPG (Pulse Pattern Generator), to pass through an object to be measured.

2. Description of the Related Art

With reference to FIG. 1, description will be made as regards a first example of a trigger signal generating circuit of a conventional bit error measuring apparatus.

In FIG. 1, a reference numeral 1 represents an M sequential random pattern generator. A reference numeral 2 represents a multiplexer (MUX). A reference numeral 3 represents a shift register. A reference numeral 4 represents comparators. A reference numeral 5 represents a flip-flop (FF).

In the trigger signal generating circuit of the bit error measuring apparatus that is illustrated in FIG. 1, a parallel pattern, which is generated from the M sequential random pattern generator 1 driven by a low speed clock signal (a), is multiplexed by the multiplexer 2 to be outputted as a serial random pattern.

In case where a pattern length of the random pattern may be, for example, 2¹⁵-1, the random pattern has a repetition period of 65535 bits.

The random pattern, which is a serial signal multiplexed by the multiplexer 2, is sequentially inputted to the shift register 3 which is driven by a high speed clock signal (b), to be compared with a predetermined waiting pattern (c) of 15 bits by the comparators 4.

Incidentally, the high speed clock signal (b) has a 16 times speed of the low speed clock signal (a) in FIG. 1.

When the comparators 4 detect that the random pattern is coincident with the waiting pattern in the pattern of 15 bits, the flip-flop 5 which is driven by the high speed clock signal (b) outputs a trigger signal.

As described above, it is possible to obtain the trigger signal which is once generated at a period of the M sequential random pattern, by setting an optional waiting pattern of 15 bits in the comparators and carrying out comparison in the comparators.

Accordingly, it is possible to obtain the trigger signal having an optional phase when varying the waiting pattern of 15 bits.

In the above-mentioned trigger signal generating circuit of the bit error measuring apparatus that is illustrated in FIG. 1, the pattern is generated in a parallel circuit of 16 bits that is used as an M sequential random pattern generating circuit, in correspondence to a high speed of communication bit rate. The pattern is multiplexed by the multiplexer.

In as much as the pattern is detected in accordance with the multiplexed serial signal of high speed, it is necessary to carry out a high speed operation in order to generate the trigger signal. As a result, it is necessary to use expensive devices each of which consumes a great power.

With reference to FIG. 2, description will be made about a second example of a trigger signal generating circuit of the conventional bit error measuring apparatus.

In FIG. 2, the reference numeral 1 represents the M sequential random pattern generator. The reference numeral 2 represents the multiplexer (MUX). The referencenumeral4representscomparators. Areference numeral 6 represents a flip-flop (FF). A reference numeral 7 represents a multiplexer (MUX).

In the trigger signal generating circuit of the bit error measuring apparatus that is illustrated in FIG. 2, the parallel pattern of 16 bits, which is outputted from the M sequential random pattern generator 1 driven by the low speed clock signal (a), is multiplexed by the multiplexer 2 to be outputted as the serial random pattern.

The random pattern, which is a parallel signal prior to being multiplexed by the multiplexer 2, is inputted to the comparators 4 through the flip-flop 7 driven by the low speed clock signal (a), to be compared with the predetermined waiting pattern (c) of 15 bits.

Incidentally, comparators 4 of sixteen are located in parallel.

In addition, the high speed clock signal (b) has a 16 times speed of the low speed clock signal (a).

When the comparators 4 detect that the random pattern is coincident with the waiting pattern in the pattern of 15 bits, the trigger signal is outputted through the multiplexer 7 which is driven by the high speed clock signal (b).

Incidentally, the multiplexer 7 is for synchronizing the trigger signal with the random pattern which is outputted from the multiplexer 2, in the bit pattern of high speed.

As described above, it is possible to obtain the trigger signal which is once generated at a period of the M sequential random pattern, by setting an optional waiting pattern of 15 bits in the comparators and carrying out comparison in the comparators.

Therefore, it is possible to obtain the trigger signal having an optional phase when varying the waiting pattern of 15 bits.

In the trigger signal generating circuit of the bit error measuring apparatus that is illustrated in FIG. 2, it is necessary to be shifted one bit apart with respect to the signal of 16 bits which are outputs from the comparators of sixteen, respectively, inasmuch as the trigger signal generating circuit has a configuration for carrying out a pattern detection, on a parallel circuit which is located between the M sequential random pattern generating circuit and the multiplexers.

In addition, the all of comparators output detection pulses at a same phase, respectively, inasmuch as each of the comparators of sixteen operates at a frequency of 1/16 of the clock signal which is for use in generating the serial signal (random pattern).

Therefore, it is necessary to multiplex the detection pulses of sixteen by the multiplexer 7 in a manner similar to the manner in which the random pattern is obtained, in order to obtain the trigger signal.

In case of the trigger signal generating circuit illustrated in FIG. 1, it is necessary to carry out the high speed operation in order to generate the trigger signal because of detecting the pattern on the basis of the multiplexed serial signal of the high speed. Furthermore, it is necessary to use the expensive devices each of which consumes the great power.

In addition, each of the multiplexers consumes the great power and is an expensive device. Furthermore, there is a problem in which entire circuit has a large scale, in the trigger signal generating circuit illustrated in FIG. 2.

### SUMMARY OF THE INVENTION

It is an object of the present invention to provide a trigger signal generating circuit for use in a bit error measuring apparatus that has one comparator with respect to a parallel signal of 16 bits and carries out a pattern detection to again control a timing of coincident output pluses outputted from the comparator, in accordance with a high speed clock signal, in order to obtain a trigger signal.

In order to solve the above-mentioned problems, in a trigger signal generating circuit for use in a bit error measuring apparatus that generates a trigger signal at an optional bit phase of an M sequential random pattern, the trigger signal generating circuit comprises:

a comparing section for comparing a predetermined waiting pattern with a parallel pattern outputted from an M sequential random pattern generator before carrying out multiplexing;

a first retiming section for carrying out a retiming with respect to a pattern coincident signal outputted from the comparing section, in accordance with a low speed clock signal; and

a second retiming section for carrying out a retiming with respect to a retiming signal outputted from the first retiming section, in accordance with a high speed clock signal;

wherein the second retiming section outputs an output signal used as the trigger signal.

In addition, the low speed clock signal may be obtained by dividing the high speed clock signal on the basis of a division ratio based on the multiplexing.

Furthermore, it may be possible to optionally vary the waiting pattern.

Furthermore, the number of bits may be equal to n in the waiting pattern in case where the length of the random pattern is equal to 2ⁿ-1.

In addition, a bit error measuring apparatus may carry out a wave observation on an oscilloscope, on the basis of the trigger signal which is outputted from any one of the above-mentioned trigger signal generating circuits.

### BRIEF DESCRIPTION OF THE DRAWINGS

FIG. 1 shows a configuration for illustrating a conventional first trigger signal generating circuit;

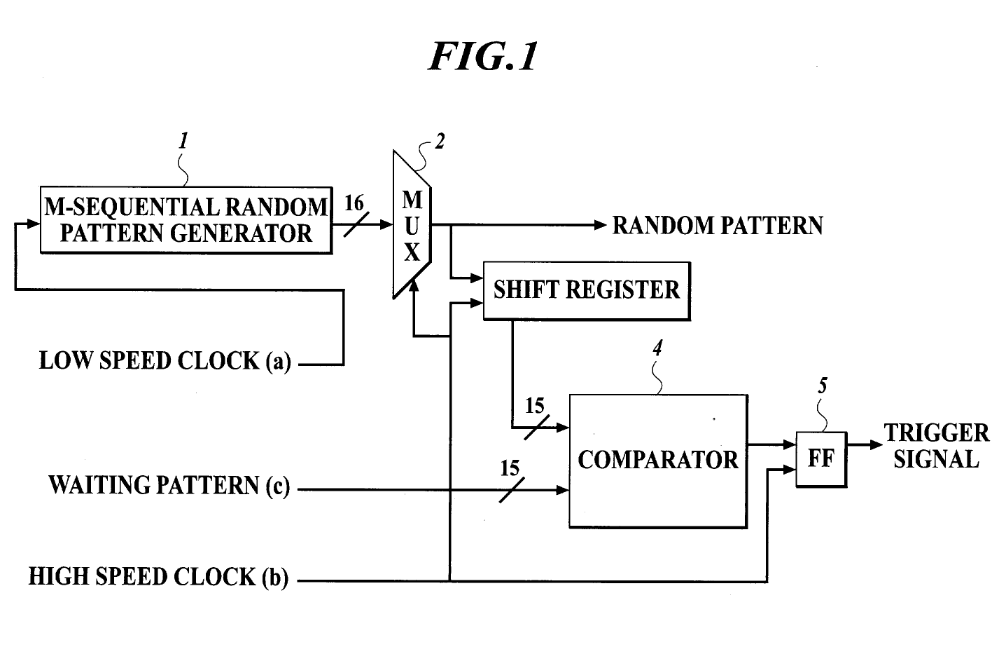

FIG. 2 shows a configuration for illustrating a conventional second trigger signal generating circuit; and

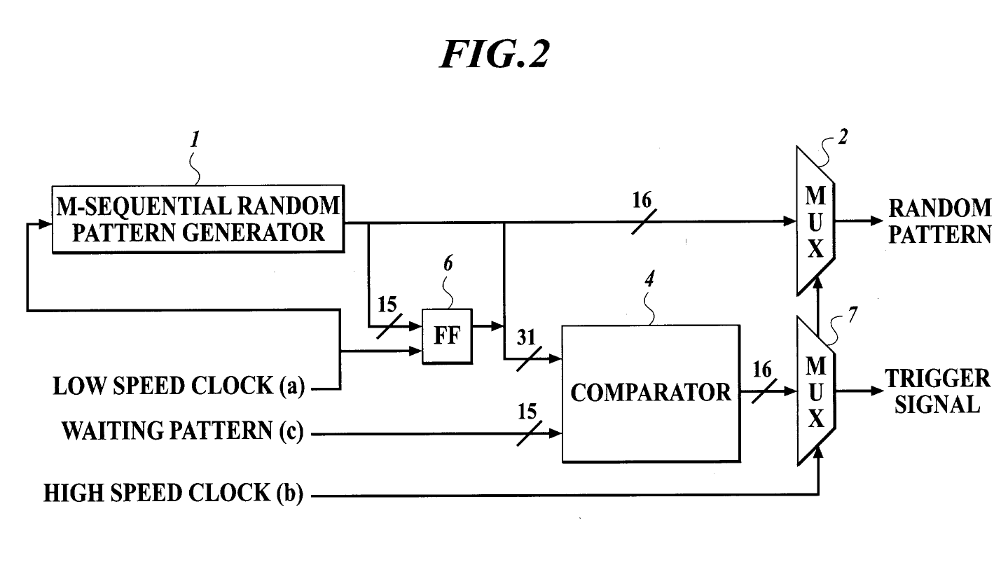

FIG. 3 shows a configuration for illustrating a trigger signal generating circuit according to a preferred embodiment of the present invention.

### PREFERRED EMBODIMENT OF THE INVENTION

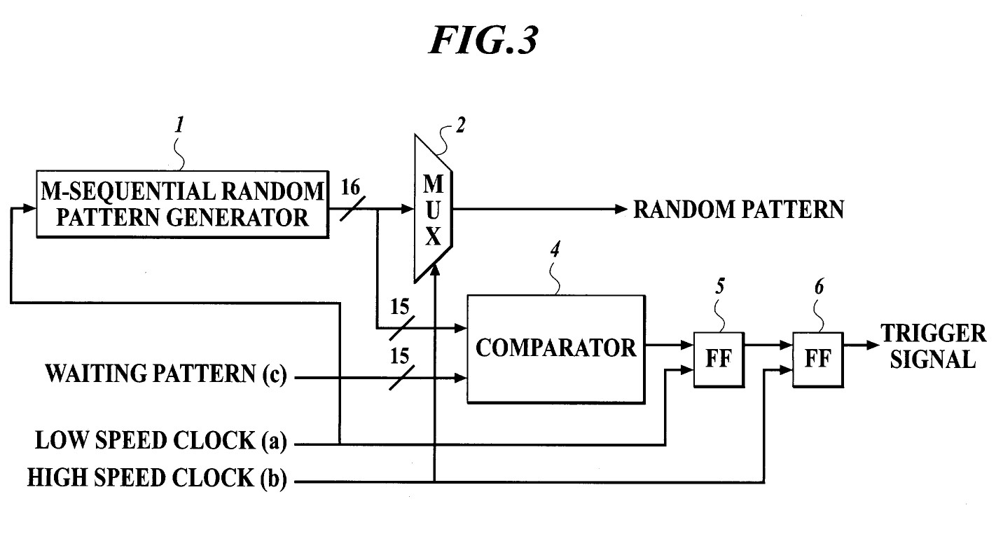

With reference to FIG. 3, description will proceed to a trigger signal generating circuit for use in a bit error measuring apparatus according to an embodiment according of the present invention.

In FIG. 3, a reference numeral 1 represents an M sequential random pattern generator. A reference numeral 2 represents a multiplexer (MUX). A reference numeral 4 represents a comparator. Each of reference numerals 5 and 6 represents a flip-flop (FF).

In the trigger signal generating circuit for use in the bit error measuring apparatus according to the present invention that is illustrated in FIG. 3, a parallel pattern of 16 bits, which is outputted from the M sequential random pattern generator 1 driven by the low speed clock signal (a), is multiplexed by the multiplexer 2 to be outputted as the serial random pattern.

The random pattern, which is a parallel signal prior to being multiplexed by the multiplexer 2, is inputted to the comparator 4 to be compared with a predetermined waiting pattern (c) of 15 bits.

Only one comparator 4 is provided in the present invention.

In addition, the high speed clock signal (b) has a 16 times speed of the low speed clock signal (a).

After a pattern coincident signal outputted from the comparator 4 is subjected to a retiming process by the first flip-flop 5 which is driven in accordance with the low speed clock signal (a), the pattern coincident signal is further subjected to a retiming process by the second flip-flop 6 which is driven in accordance with the high speed clock signal, to be outputted as the trigger signal.

In this case, it is possible to output the trigger signal at an optional phase when variation is carried out with respect to the waiting pattern of 15 bits.

In the trigger signal generating circuit for use in the bit error measuring apparatus according to the present invention that is illustrated in FIG. 3, it is possible to decrease scale or size of circuits for use in generating the trigger signal, inasmuch as only the flip-flop 7 is used as a high speed device which needs to generate the trigger signal.

In addition, it is possible to output the trigger signal at the optional phase in a step of one bit with respect to the serial signal even though the pattern is detected on the basis of the parallel data of 16 bits.

Incidentally, the pattern coincident signal is once generated at sixteen periods of the M sequential random pattern because the waiting pattern of 15 bits is shifted at each one period of the M sequential random pattern in the trigger signal generating circuit for use in the bit error measuring apparatus according to the present invention, inasmuch as the number of parallel bits is equal to sixteen bits. There is no problem in which the wave observation is carried out by the oscilloscope inasmuch as the pattern has a short repetition period in case where the bit rate is a high speed.

According to the present invention, it is possible to decrease scale of circuits for use in generating the trigger signal inasmuch as only flip-flop is used as the high speed device for generating the trigger signal, in the trigger signal generating circuit for use in the bit error measuring apparatus that generates the trigger signal at the optional bit phase of the M sequential random pattern, when the trigger signal generating circuit comprises the comparing section for comparing the predetermined waiting pattern with the parallel pattern outputted from the M sequential random pattern generator before carrying out multiplexing, the first retiming section for carrying out the retiming with respect to the pattern coincident signal outputted from the comparing section, in accordance with the low speed clock signal, and the second retiming section for carrying out the retiming with respect to the retiming signal outputted from the first retiming section, in accordance with the high speed clock signal, and the second retiming section outputs the output signal used as the trigger signal.

In addition, it is possible to output the trigger signal at the optional phase in the step of one bit with respect to the serial signal even though the pattern is detected on the basis of the parallel data of 16 bits, according to the present invention.

Furthermore, there is no problem in which the wave observation is carried out with respect to the bit pattern by the oscilloscope inasmuch as the bit rate is the high speed and the pattern has the short repetition period when the wave observation is carried out with respect to the bit pattern on the basis of any one of trigger signals each of which is described above, according to the present invention, although the pattern coincident signal is once generated at sixteen periods of the M sequential random pattern.

What is claimed is:

1. A trigger signal generating circuit for use in a bit error measuring apparatus that generates a trigger signal at an optional bit phase of an M sequential random pattern, comprising:
a comparing section for comparing a predetermined waiting pattern with a parallel pattern which is outputted from an M sequential random pattern generator, before carrying out multiplexing;
a first retiming section for carrying out a retiming with respect to a pattern coincident signal which is outputted from the comparing section, in accordance with a low speed clock signal; and
a second retiming section for carrying out a retiming with respect to a retiming signal which is outputted from the first retiming section, in accordance with a high speed clock signal;
wherein the second retiming section outputting an output signal used as the trigger signal.

2. The trigger signal generating circuit for use in the bit error measuring apparatus as claimed in claim 1, wherein the low speed clock signal is obtained by dividing the high speed clock signal on the basis of a division ratio based on the multiplexing.

3. The trigger signal generating circuit for use in the bit error measuring apparatus as claimed in claim 1, wherein the waiting pattern is optionally varied.

4. The trigger signal generating circuit for use the bit error measuring apparatus as claimed in claims 1, wherein the number of bits is equal to n in the waiting patttern in case where the length of the random pattern is equal to 2ⁿ-1.

5. A bit error measuring apparatus carrying out a wave observation on an oscilloscope, on the basis of the trigger signal which is outputted from the trigger signal generating circuit claimed in any one of claims 1 to 4.
